(19) United States
(12) Patent Application Publication
(10) Pub. No.: US 2009/0322521 A1
(43) Pub. Date: Dec. 31, 2009

(54) SYSTEM AND METHOD FOR UTILIZING A SECURITY BEACON DEVICE

(76) Inventor: Kirk D. Jacobson, Peoria, AZ (US)

Correspondence Address: PROCOPIO, CORY, HARGREAVES & SAVITCH LLP, 530 B STREET, SUITE 2100, SAN DIEGO, CA, 92101, US

(21) Appl. No.: 12/108,814

(22) Filed: Apr. 24, 2008

Related U.S. Application Data
(60) Provisional application No. 60/914,285, filed on Apr. 26, 2007.

(51) Int. Cl. G08B 21/00

(52) U.S. Cl. 340/540

(57) ABSTRACT

Methods, devices and systems for implementation in a campus environment including an interface module, a storage device and a server. The interface module configured to receive user profile information. The storage device may be coupled to the interface module for storing the user profile information. The server may be coupled to the storage device and configured to receive a user message initiated in response to a trigger event. The user message may include a security beacon device identification information, user profile information, and trigger event message. The server may be configured to process the user message to identify the security beacon device and to associate the security beacon device with the user profile information in the storage device. The user message may be analyzed at the server in order to determine the appropriate response to the trigger event associated with the received user message.

### RELATED APPLICATION

This application claims the benefit of U.S. Provisional Patent Applications Ser. No. 60/914,285, filed Apr. 26, 2007, entitled “System And Method For Utilizing A Security Beacon Device” which is hereby incorporated by reference in its entirety.

### FIELD OF THE INVENTION

This invention relates to the field of security systems and more specifically to security systems for personal security.

### BACKGROUND OF THE INVENTION

The recognized need for improved personal security and emergency response capability has been documented in various prior art. In situations where an individual is injured, lost, or abducted, immediate notification of an emergency situation including location of the emergency to a local law enforcement or emergency response organization is required to maintain the safety of the individual and to mitigate or avoid severe and or tragic situations.

One problem encountered by personal security systems is that a host computer can only initiate communications within the personal security system, for example to communicate with remote devices. Individuals associated with the remote devices and/or personnel associated with the system have no additional means of communicating various conditions within the system. For example, in situations where the system is susceptible to emergency situations and/or unforeseen events, it may be beneficial to enable users and other personnel the ability to flexibly initiate communications in response to an emergency.

Accordingly, there is a need for personal security systems that overcome the shortcomings of the prior art.

### SUMMARY

The present invention includes methods, apparatuses, and systems as described in the written description and claims. In one embodiment, a system for personal security includes an interface module, a storage device and a server. The interface module may be configured to receive user profile information and for editing the user profile information. The storage device may be coupled to the interface module for storing the user profile information. The server may be coupled to the storage device and configured to receive a user message initiated in response to a trigger event. The user message may include a security beacon device identification information, a user profile information, and a trigger event message. The server may be configured to process the user message to identify the security beacon device and to associate the security beacon device with the user profile information in the storage device. In some embodiments, the server may be configured to determine the appropriate response to the trigger event associated with the received user message. In other embodiments the user message is forwarded to an operator to determine the appropriate response to the trigger event.

In another embodiment a security beacon device for personal security includes an activation module, a processing module and a transmitting module. The activation module may be configured to transition the security beacon device from a passive state to an active state in response to an activation signal at the security beacon device. The activation signal may initiate a process in the activation module that causes the security beacon device to transition from the passive state to an active state. The processing module may be coupled to the activation module and configured to create a user message in response to the activation of the security beacon device. The user message may include security beacon device identification information, user profile information, and trigger event message that initiates a response process at a server, for example, for addressing the trigger event associated with the user message. The transmitting module may be coupled to the processing module and configured to transmit the user message from the processing module to the server for addressing the trigger event associated with the user message.

In some embodiments, a method for personal security includes receiving user profile information associated with a security beacon device and storing the user profile information in a storage device accessible to a server. The method may also include transitioning the security beacon device from the passive state to an active state in response to an activation signal initiated in response a trigger event. A user message may be created in response to the activation of the security beacon device, where the user message may include security beacon device identification information, user profile information, and trigger event message. The user message may then be transmitted from the security beacon device to the server and processed at the server to identify the security beacon device and to associate the security beacon device with the user profile information in the storage device. In some embodiments the user message is analyzed at the server and a determination is made to identify an appropriate response to the trigger event. The method may also include forwarding the user message to an appropriate authority for addressing the trigger event.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a system according to one embodiment of the invention;

FIG. 2 is a block diagram of a security beacon device according to one embodiment of the invention;

FIG. 3 is a diagram of an output message according to one embodiment of the invention; and

FIG. 4 is a block diagram of a server according to one embodiment of the invention.

FIG. 5 is an example of a method for implementation in a campus environment in accordance with an embodiment.

### DETAILED DESCRIPTION

After reading this description, it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

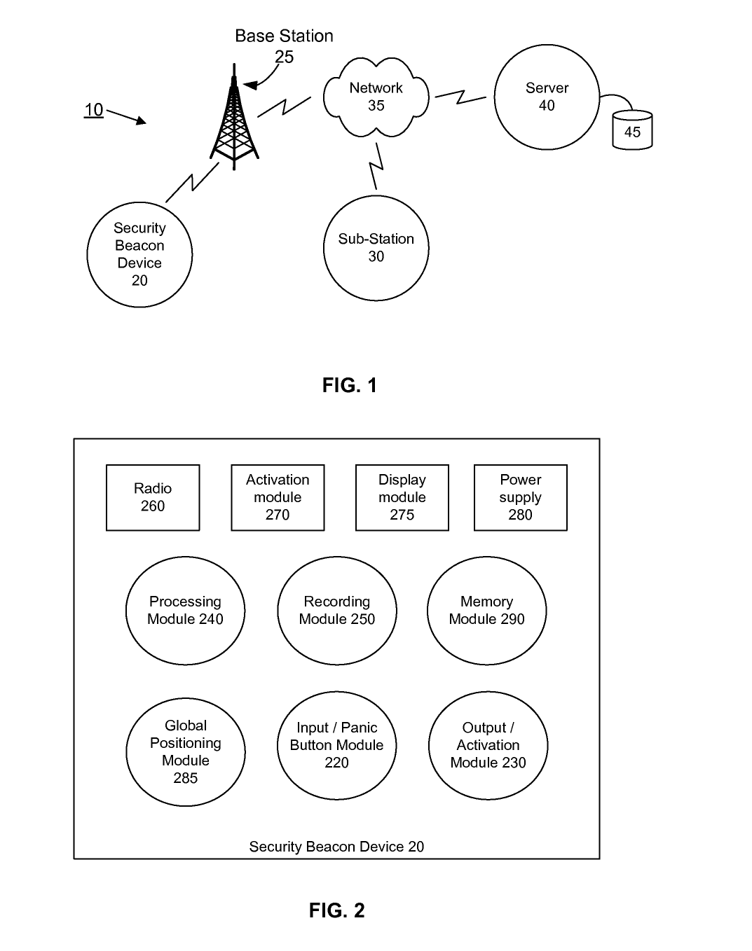

In one aspect, a system and method for utilizing a security beacon device is provided. FIG. 1 is a block diagram of a system according to one embodiment of the invention. In general, one embodiment of the system 10 includes a security beacon device (or device) 20. The security beacon device 20 communicates with a server 40 via a wireless base station 25 and a network 35. An individual uses the security beacon device 20 during an emergency, for example, by pressing a button or input mechanism on the security beacon device 20. In response to pressing of the button, the security beacon device 20 generates an output message, which the security beacon device 20 transmits to the server 40 via a base station 25 and a network 35.

In one embodiment, multiple buttons can indicate different levels of safety status according to the severity of the trigger event (e.g. emergency). An historical study of reports received from internet or mobile users, for example, can provide a break down of levels of safety status based on the trigger events. The different levels of safety status can be identified by color codes for simple operation in the time of crisis. For example, red may indicate a crisis where police support is required, an orange may indicate a situation where safety has been compromised, yellow may indicate an elevated safety risk, blue may indicate slight safety concern and green may indicate no safety concern. The different levels of safety may also be represented by other schemes, for example, SMS message or with other color-coding schemes. Buttons on the security beacon device 20 may be colored according to the colors representing the levels of safety. In other embodiments different keys or coding schemes can represent the different levels of safety. The means for initiating the activation signal may be defined by the user for ease of operation in the time of an emergency. In one embodiment upon receipt at the server 40 of an output message or user message indicating the level of safety status, an alert may be sent by the server to all the security beacon device 20 in the system, for example, or to those security beacon device 20 that are within the vicinity of the emergency. In one embodiment the alert sent by the server may be in the form of a text message and the user of the security beacon device 20 may respond with a status information. The server 40 can also receive multiple output messages or user messages from the same or other security beacon devices 20 for the same emergency. The output message generated upon a trigger event can be received by one or more entities (e.g. fire department, campus patrol, local police, administrator etc) that may be defined by the user or a group/organization administrator. In some embodiments the output message may be processed at the server and a determination is made as to the appropriate entity or authority to receive the output message or user message. The user message may include other user profile information relevant to address the trigger event.

The server 40 receives the user message and parses the user message into its component parts, for example, information about the user, information about the security beacon device 20, and information about the location of the security beacon device 20. The server 40 may use the component parts of the output message to determine the appropriate entity to contact in response to an analysis of the output message at the security beacon device 20 or at the server 40. The appropriate entity may be, for example, a law enforcement authority, a medical emergency response entity or an operator that can parse the output message and forward to the appropriate authority. In one embodiment, two-way communication can be established between the operator, for example, and the user of the security beacon device so that voice data (audio), for example, from the user can be received by an operator or by the server 40 and recorded. In one embodiment the server 40 may also returns a signal to the security beacon device 20, thereby activating the security beacon device 20. In another embodiment, the security beacon device 20 may be activated by the user or may be activated by a pre-determined process that is triggered by the occurrence of an event. The activation of the security beacon device 20 may be indicated by, for example, the activation of light emitting diodes (LEDs) on the security beacon device 20 and/or the activation of a black box recording that records any audio at or near the location of the device. The black box recording of the audio may also includes a live audio or a recorded feed.

The server 40 can communicate with the security beacon device 20 and a sub-station 30. There are a variety of types of wireless devices and networks that can be used. Examples include personal communication services (“PCS”), global system for mobile communications (“GSM”), code division multiple access (“CDMA”) cell phones and networks, wireless fidelity (“WiFi”) networks, or worldwide interoperability for microwave access (WiMAX) networks. As it pertains to the embodiments discussed above and below, the particular protocols of the security beacon device 20 and the network 35 are immaterial so long as it is possible to exchange voice and/or data to and from the security beacon device 20. In an alternative embodiment, the server 40 is not used and the security beacon device 20 communicates with the sub-station 30 directly via the base station and the network 35.

The network 35 represents those aspects of a wireless network, such as a cellular telephone network, that are not explicitly depicted in FIG. 1. While FIG. 1 illustrates the sub-station 30 and the server 40 as communicating directly with the network 35, the sub-station 30 and the server 40 may also communicate indirectly with the network 35. For example, the sub-station 30 and the server 40 may be operated with one or more servers connected to the network 35 through another network, such as the Internet.

The server 40 may include a data storage system 45 such as a database. In the alternative embodiment where the sub-station receives communications from the device, the data storage system can be a component of the sub-station. As used herein all aspects of the server and the sub-station can be interchangeable in that any components shown as being part of the server can also be implemented at the sub-station and vice-versa.

It should be noted that many components that are included in the elements of FIG. 1 and the subsequent figures have been omitted to make the descriptions more clear. One will note that these omitted elements such as processors, network ports, memories, buses, transceivers, etc., would be included in such elements in a manner that is commonly known to those skilled in the art.

FIG. 2 is a block diagram of a security beacon device according to one embodiment of the invention. The security beacon device 20 may include a transceiver module 260 having a transmitting and receiving module, for example a radio or a transceiver. The device 20 also includes an activation module 270, a display module 275, for example output hardware, a power supply 280, a processing module 240, a recording module 250, a memory module 290, an input/panic module 220, a global positioning module 285 and an output activation module 230.

The security beacon device 20 can be a small, compact design so that it can be easily accessible from a keychain, a belt loop, a lanyard, an armband, a clip, etc. In one embodiment the security beacon device 20 can be enclosed by a casing. The casing can be water resistant and able to survive for a period of time if submerged in water (i.e., a fountain, a pool, a bath tub, a toilet, a puddle, etc.). The casing can be heat tolerant to ensure that the signal derived from the security beacon device 20 continues for a longer period of time. The heat tolerance of the casing can protect against damage due to overheating caused by the device being left in direct sunlight or in a car. The casing can also be shock resistant and/or otherwise able to withstand a crushing impact. The security beacon device 20 may have a device identifier, for example a serial number, on the security beacon device 20 and/or on each individual casing. The casing on the security beacon device 20 can be either a permanent part of the device or detachable (replaceable shell).

The transceiver module 260, for example a radio, is a device capable of transmitting/sending and receiving modulated radio waves containing information. The information may be propagated through space as a means of communication between the security beacon device 20 and the server 40. Example protocols that the radio can implement include code division multiple access (CDMA) or global system for mobile communications (GSM). The radio can be implemented using standard chipsets available from vendors, including Motorola, Fujitsu, Qualcomm, or any other suitable vendor.

The activation module 270 can be configured to transition the security beacon device 20 from a passive state to an active state. The activation module 270 may include, for example a switch, a button or a microphone. In one embodiment user may depress the button when a trigger event occurs, for example emergency, which in general initiates an activation signal that starts a process in the activation module 270 that causes the security beacon device 20 to transition from a passive state to an active state. In some embodiments the input/panic button module can be used to initiate the activation signal in the security beacon device 20.

The process in the activation module 270 can be initiated by depressing a button to indicate an emergency or by holding the button down for a pre-determined period of time (e.g., three seconds or longer) to indicate a medical emergency, for example. Alternatively, more than one input button can be provided to indicate different trigger events.

The button, can be enclosed by a safety slide cap that rests over the button, protecting against accidental activation of the device. The safety slide cap can slide either away from the bottom of the device or towards the bottom of the device and can slide into the device or be controlled by external mechanics. A small spring latch or pressure fitting can ensure that the cap stays down until the individual desires to push it forward.

The activation module 270 may also be configured to activate the recording module 250. The recording module 250 includes a microphone on the security beacon device 20 that may be used for capturing voice data or the sounds of the general surroundings of the security beacon device 20. The recording module 250 can be configured to record the general surroundings of the device or voice data by activating the microphone when the device enters the active state. The audio that the recording module 250 records can be sent to the memory module 290 as well as to the server 40 as a component of the output or user message that is conveyed as a signal by the transceiver module 260.

In other embodiments other forms of recording or reporting devices available on the security beacon device 20 may be activated that can be used to fully analyze the trigger event to determine a cause of action at the server 40 or at the security beacon device 20. For example the security beacon device can include a digital camera.

The security beacon device 20 may also include a display module 275. The display module 275 can be a display screen and/or one or more LEDs, which can indicate that the security beacon device 20 has gone from a passive state to an active state. Alternatively, the display module 275 may be excluded from the security beacon device 20 or disabled.

The power supply 280 may be configured to provide the power for the security beacon device 20. The power supply 280 can include a battery, either rechargeable or disposable and either interchangeable or fixed, for example. The power supply can also include a capacitor (E.g. slow discharge or long life).

The memory module 290 may be a random access memory (RAM), a read only memory (ROM), flash memory, a hard disk drive, or a combination of these types of memory devices. In some embodiments the memory module 290 may also store identification information for the security beacon device 20 that may be used to associate the security beacon device 20 with a user profile information, for example. The memory module can also store recordings of the surroundings of the security beacon device. In one embodiment the memory module 290 and the processing module 240 may be external to the security beacon device 20. The memory module 290 may be associated with the storage device 45 illustrated in reference to FIG. 1 above. In other embodiments the processing module 240 may be associated with the server 40 illustrated in reference to FIG. 1 above. The processing module 240 may be coupled to the activation module and configured to generate a user message in response to the activation of the security beacon device 20. The processing module 240 can be implemented in a chipset, such as an assisted global positioning system (AGPS) chipset. The processing module 240 may receive signals from a GPS system or from the server and processes the received signals. The signals from the global positioning system can be received by the global positioning module 285 at the security beacon device 20 and/or at the server 40.

When the device transitions to the active state, the output activation module 230 may generates an output message that can be transmitted by the transceiver module 260 to the server 40 for processing via the network 35, for example. In one embodiment the output activation module 230 or the processing module 240 can generate the user or output message. The output message can include information identifying the security beacon device 20, the user of the security beacon device 20, whether the current transition to an active state indicates an emergency and location information associated with the security beacon device 20.

In one embodiment, the security beacon device 20 can transition from a passive to an active state, when the device moves outside of or into a pre-defined area or territory. The pre-defined territory may be referred to as a geo-fence. A geo-fence defines boundaries on a map so that the security beacon device 20 issues an emergency signal when it is out of or inside of the set boundaries. The geo-fence can include, for example, a set of latitude and longitude pairs defining a polygon that are stored in the memory module 290 and compared against GPS data that the processing module 240 continually receives. The security beacon device 20 can be associated with a plurality of geo-fences. In one embodiment, the boundaries of the geo-fence may be the boundaries of a campus environment.

The geo-fence data can be stored in the memory module 290. The processing module can compare the current location of the security beacon device 20 to the boundaries of the geo-fence and initiates the generation of the output message by the output activation module 230 in response to a determination that the device is outside of or inside of a geo-fence. Alternatively, the server 40 can make the determination as to whether the security beacon device 20 is inside of or outside the geo-fence. Accordingly, the output activation module 230 can periodically generate the output message for transmission to the server 40 and the server 40 can make the calculation and potentially activate the security beacon device 20 based on location information in the output message.

In one embodiment, the security beacon device 20 may be implemented in a modified communication device, for example a cellular telephone, personal digital assistant, a pager or a computer. The modified communication device may include an algorithm or application configured to implement the function of the security beacon device 20 on the modified communication device. The algorithm may allow for recognition and monitoring of the modified communication device from a remote monitoring entity, for example the server 40. The application may be downloaded from, for example, the server 40 or from a website, and stored on the modified wireless device. In one embodiment the application may run silently behind the scenes and the user can sign into the application with a user name and password, for example. In one embodiment the user can define a static location for the modified communication device including address, office number, apartment, dorm room etc. The static location can also be plotted on a map or retrieved from a stored user defined location. The activation of the modified communication device can be customized such that a default keystroke, for example space bar+ctrl/cmd, may be used to activate the modified communication device.

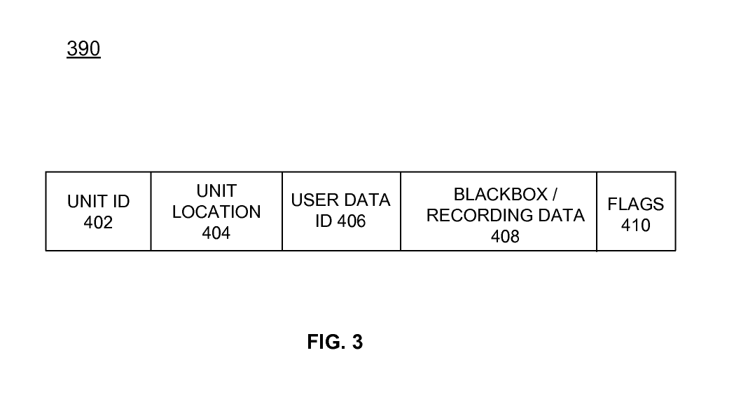

FIG. 3 is a diagram of an output or user message according to one embodiment of the invention. The output message can be the output message 390 generated by the output activation module 230 of FIG. 2. The output message can also be the user message generated by the processing module 240 of FIG. 2. The output message can include various message elements including a unit ID 402, a unit location 404, a user data ID 406, black box/recording data 408, and flags 410. In various embodiments, some elements of the output message may or may not be included. In some embodiments, the output activation module 230 can generate some of the message elements in combination, for example, the user data ID and the device ID can be generated as a single block. In some embodiment the output messages can incorporate flags to indicate different trigger events, for example, setting a flag to false can indicate that the present output message is not an emergency.

The example of FIG. 3 is merely one way the device can form the output message. In general, the user can activate the device by sliding up the safety slide cap and pressing the activation button. Alternatively, the sub-station 30 or server 40 can initiate an automatic message sending sequence on the security beacon device 20 remotely. In either case the output message can be an e-mail, a voice message, a data message, a short message service (SMS) message, or a packet sent over a wired or wireless network such as the Internet, a WiFi network, a WiMAX network, an over-the-air network, or the like.

In general, regardless of the type of message the security beacon device 20 sends, the message can have the following properties:
The message includes an identifying sequence such as the unit ID so that the recipient of the message (e.g., the server or the sub-station) is able to recognize the security beacon device 20 as the source of the message;
The message includes a block that allows the recipient of the message to access a user profile associated with the security beacon device 20 so that the recipient can ascertain information about the individual who presumably is indicating that they are in an emergency situation;
The message includes a block with location information that allows the recipient of the message to determine the location of the security beacon device 20. For example, the processing module 240 can receive GPS coordinates such as latitude, longitude, and altitude and these coordinates can be output in the output message;
The message includes a block with at least a portion of the black box recording from the recording module 250 that allows the recipient of the message to ascertain more information of the environment where the device is located;
The output message can be periodically sent out every at pre-determined time intervals, (e.g., 3 seconds). In one embodiment, each time the security beacon device 20 sends out the message, a new portion of the recording can be included so that the entire recording is received by either the server or the sub-station over time and reassembled there;
The security beacon device 20 can send the output message on a schedule for an activity or diagnostic check (e.g., not an emergency notice);
The security beacon device 20 can send the output message indicating a low battery notification (e.g., not an emergency notice); and
In one embodiment, when the security beacon device 20 sends a non-emergency signal it can set the flags so that the recipient can determine that the message is not an emergency.

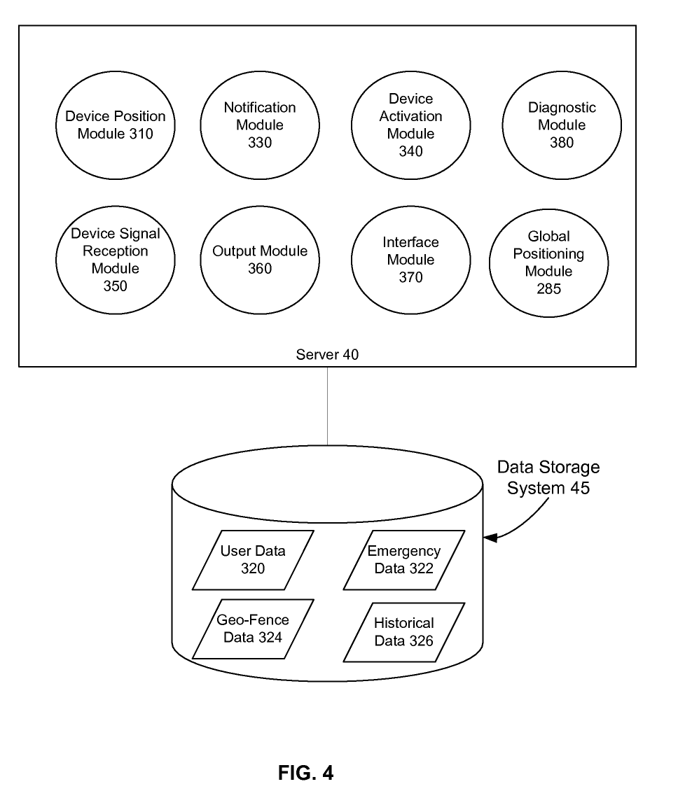

FIG. 4 is a block diagram of a system including a server according to one embodiment of the invention. The system may include an interface module 370, a server 40, and a data storage system 45. The interface module 370 may be included in the server 40 or may be external to but coupled to the server 40. The server 40 shown in FIG. 1 and may be coupled to a data storage system 45. The server 40 may include a device position module 310, a notification module 330, a device activation module 340, a diagnostic module 380, a device signal reception module 350, an output module 360, a global positioning module 285, and an interface module 370. These modules may also be located in whole or in part in the sub-station 30. The data storage system 45 may include user data 320, emergency data 322, geo-fence data 324, and historical data 326.

The interface module 370 allows an operator or user to set-up user accounts, for example, to receive a user profile information. The interface module 370 can also allow a user or operator to manage, add, and edit user profile information and other information fields related to the user. The interface module 370 can allow an operator to set-up a geo-fence, which can be provided to the memory module 290 of the security beacon device 20 and can be stored as geo-fence data in the data storage system 45. The interface module can be a computer terminal, for example.

The device signal reception module 350 can receive the output signal or message from the security beacon device 20 containing the output message and it can extract the components of the message, for example, by parsing it (e.g., breaking the message up into its component parts). The device signal reception module can extract information from the device's output message, such as the user data ID so that it can access the user profile information in the data storage system 45 for identification. The device signal reception module 350 can determine that an output message is not an emergency signal (e.g., a low battery) by examining the flags in the output message. The device signal reception module 350 can receive the non-emergency output message and can record it in the data storage system 45 as user data.

The device position module 310 can be coupled to the device signal reception module 350 and can be configured to receive the security beacon device 20 location from the output message (e.g., latitude and longitude). The device position module 310 can also be configured to determine the location of the device and/or use the security beacon device 20 location over time as historical data for re-creating the historical position of the device. (e.g., where has the user moved since the security beacon device 20 became active.)

In one embodiment, the device activation module 340 can receive notice that the security beacon device 20 has sent an emergency output message and it can send a signal to the security beacon device 20 activating it. The signal from the device activation module 340 can cause the security beacon device's 20 output activation module 230 to flash the LED lights, for example, and can initiate the recording module 250 in the security beacon device 20, for example.

The notification module 330 can respond to the storing of the output message in various manners, for example, the notification module 330 can provide a notification to any individuals operating the server 40. The notification module 330 can also send an email to the provided email address of the user whose user profile information is stored in the data storage system 45, or call the user. The server 40 can receive the emergency output message and can record it in the data storage system 45 and the notification module 330 can alert a dispatcher and provide the dispatcher with user profile information including identification information for the user and location information from the security beacon device 20.

In one embodiment, if the security beacon device 20 is outside of a geo-fence or in an active state, the notification module 330 may access an emergency data in order to contact the appropriate authorities and it may also attempt to contact the user. In some embodiments if no contact can be made with the user, the server 40 treats the lack of contact as an emergency.

The output module 360 can send messages via e-mail, SMS, etc., prompting the user to select whether or not they will be in certain areas at certain times (e.g., will a student be on campus during holidays and breaks), so as to not cause an internal false alarm on the security beacon device 20. The output module 360 can keep track of false alarms from the security beacon device 20 as well as information associating the false alarm with a penalty fee in some embodiments. The output module 360 can log changes relating to the user profile information including user profile change dates, log time, employee and keystrokes. The output module 360 can also log information relating to emergency activation of the security beacon device 20 including when the emergency signal came in, when it was received, when a responder was dispatched, and when they arrive on scene. This information can then later become a part of a report. The log can also include a comment space for a description of the scene when the responder arrived and what actions were taken. The logging process can be based on a user ID system that identifies who logged on to the server and what they did.

The recording from the black box on the device can be tagged by the output module 360 and attached to a file, time stamped, and flagged before being logged to the data storage system 45. The recording can be in the form of an audio file such as a waveform audio file (“WAV”), a motion pictures expert group file (“MPEG”), an audio video interleave file (“AVI”), an MPEG layer 3 file (“MP3”), or a similar file for each recording.

The output module 360 can also display a map and as the server 40 logs the location of the device in the active state to the historical data, the output module 360 can display the security beacon device's 20 movements in real-time plotted on a map. In some embodiments the estimated margin of error in a radius around the plotted point can be determined by the output module 360. Jurisdiction dispatch numbers for example, police, emergency medical technician (EMT), fire department can be provided by the output module 360 from the data storage system 45 in accordance with the location of the security beacon device 20. In one embodiment the user can define the location of the security beacon device 20 including address, GPS coordinates, and other information tagged by the user. The output module 360 can generate a report, for example, periodically, of all information logged to the data storage system 45. A report can combine output message received from the security beacon device 20 including user profile information, identification information and location and map of the security beacon device 20. The report may also include recording of all transmission from the security beacon device 20 including audio, location and status information.

The diagnostic module 380 can log diagnostic information about the security beacon device 20. The diagnostic information can include device history, a log of when the device went in service, a log of any repairs on device, a log of any battery issues/replacement, a log of any ping report whether activated internally or by device's scheduled activity/diagnostic check, the battery level at the time of the ping and the location of the device at the time of the ping.

In one embodiment, the user profile information can include photos of users, (front, side, profile views) any unique characteristics, full legal name, any known alias, height, weight, age, nationality, any pertinent medical information (e.g. allergies, afflictions, blood type etc), contact information, home phone, mobile phone, parent/guardian phone, roommate name, roommate phone, friend name, friend phone, address, e-mail, work, likely hangouts, login, password, serial number of the device, who to contact in case of emergency, user defined locations, locations frequented by user (e.g. home, classroom, office, dorm room etc.) In some embodiments a group profile can be created and managed by the system. For example a parent can access and edit the user profile information of a child (minor), a manager can track employee during work hours, for example, and a legal adult can give permission for others to access the legal adults location information.

The present system and method can be implemented at a location such as a college campus or similarly situated entity using the following overall scheme:
Paperwork is sent out with marketing materials or application packets;
Education and sign-up period scheduled in with orientation providing a time to educate individuals on the functions of the device;
Security beacon devices 20 are assigned with an automated process of either a serial number or a barcode system;
Payment can be integrated with sign-up, for example payment can be submitted to a University bursar account when the individual registers for classes;
Like all other payments, class credit/registration/graduation flagged with outstanding balance;
Payments to be submitted include, but are not limited to: an initial enrollment fee; a recurring service charge; any replacement or false alarm fees;
Payments can be sent from the entity (e.g., University) to the owner of the server; and
The sub-station can be integrated with the entity (e.g., University) with security or police responders.

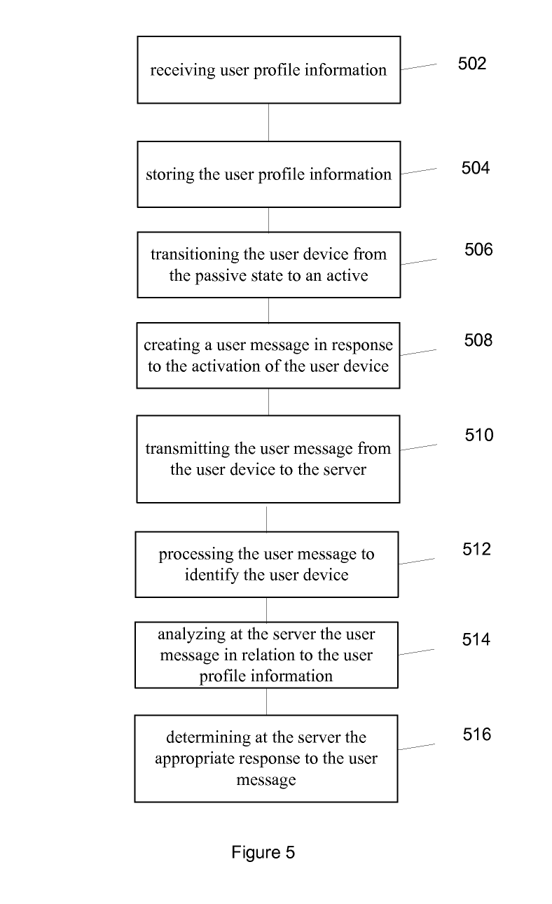

FIG. 5 is an example of a process for implementation in a campus environment in accordance with an embodiment. The steps of this process may be implemented in the security beacon device, for example the security beacon device 20 of FIG. 2 and the server 40 of FIG. 4.

At step 502 the process starts with receiving user profile information associated with a security beacon device at an interface module 370 illustrated in FIG. 4 above. In step 504 the user profile information is stored in a storage device, for example data storage system 45 that is accessible to the server 40. The process then continues to step 506 where the security beacon device 20 transitions from the passive state to an active state upon receipt of an activation signal in response to a trigger event, for example, an emergency situation. In step 508 a user message may be created in the processing module 240 in response to the activation of the security beacon device 20, where the user message may include security beacon device identification information, user profile information, and trigger event message. The process then continues to step 510 where the user message may then be transmitted from the security beacon device 20 to the server 40 in response to the trigger event that initiated the activation of the security beacon device.

In step 512 the user message is processed to identify the security beacon device and to associate the security beacon device with the user profile information in the storage device. The user message is then analyzed at the server in step 514 to determine an appropriate response to the trigger event. Finally, in step 516 a determination is made at the server 40 as to the appropriate response for addressing the trigger event. In one embodiment the relevant information is displayed to an operator. The operator then responds to the information. For example, the operator can initiate a call to the appropriate law enforcement organization based upon the location of the user. In another embodiment the relevant information is provided directly to a law enforcement authority, for example. In some embodiments the method may also include forwarding the user message to an appropriate authority for addressing the trigger event and preparing a report in response to the user message for forwarding to the appropriate authority for addressing the trigger event.

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the security beacon device, server, and sub-station and design constraints imposed on the overall system. Skilled persons can implement the described functionality in varying ways for each particular security beacon device, server, and sub-station, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), a security beacon device, server, and sub-station specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as a security beacon device, server, and sub-station specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system utilizing a security beacon device for personal security comprising:
a storage device storing user profile information;
a security beacon device comprising
an activation module configured to transition the security beacon device from the passive state to an active state in response to an activation signal at the security beacon device;
a processing module coupled to the activation module and configured to create a user message in response to the activation of the security beacon device, wherein the user message comprises security beacon device identification information, user profile information, and a trigger event message,
a transmitting module coupled to the processing module and configured to transmit the user message from the processing module via a communication network; and
a server coupled to the storage device and in communication with the communication network, the server configured to receive the user message, wherein the server is configured to process the user message to identify the security beacon device and to associate the security beacon device with the user profile information in the storage device.

2. The system of claim 1, wherein the server is configured to determine an appropriate response to address the user message initiated by the trigger event.

3. The system of claim 1, wherein an operator receives the user message and determines the appropriate response to address the user message initiated by the trigger event.

4. The security beacon device of claim 1, further comprising a recording module that is activated by the activation module in response to the trigger event.

5. The system of claim 1, wherein the user message comprises information about the location of the security beacon device.

6. The system of claim 1, wherein the activation module is programmed to identify a trigger event and to initiate the activation signal at the security beacon device in response to the trigger event.

7. The system of claim 1, wherein the server is configured to initiate an activation signal to multiple security beacon devices to alert the multiple security beacon devices of the trigger event.

8. The system of claim 1, wherein the processing module is configured to detect a trigger event including when the security beacon device is moved outside or inside of a pre-determined territory.

9. The system of claim 1, wherein the user profile information comprises user defined location including location points created, polled and tagged by the user.

10. The system of claim 9, wherein the predetermined territory includes a territory within a campus environment.

11. The system of claim 1, wherein the processing module receives location signals from a global positioning system.

12. The system of claim 1, wherein the security beacon device further comprising an output activation module configured to periodically generate an output message for transmission to the server for analysis.

13. The system of claim 12, wherein the server is configured to initiate an activation signal for the security beacon device based on an analysis of the information in the output message.

14. The system of claim 12, wherein the output message comprises location information or recordings of the surrounding environment of the security beacon device.

15. A method for improving safety comprising:
transitioning the security beacon device from the passive state to an active state in response to an activation signal at the security beacon device in response to a trigger event;
generating a user message in response to the transition of the security beacon device to the active state, wherein the user message comprises security beacon device identification information, user profile information, and trigger event message
transmitting the user message from the security beacon device to the server;
processing the user message to identify the security beacon device, the location of the security beacon device and to associate the security beacon device with the user profile information in the storage device;
analyzing the user message in relation to the user profile information to determine an appropriate response to the trigger event.

16. The method of claim 15, further comprising determining at the server the appropriate response to the user message for addressing the trigger event.

17. The method of claim 15 further comprising receiving the user message by an operator and determining at the server the appropriate response to the user message for addressing the trigger event.

18. The method of claim 15, further comprising preparing a report in response to the user message and forwarding the report to an appropriate authority for addressing the trigger event.

19. A security beacon device for improving personal security comprising:
an activation module configured to transition a security beacon device from a passive state to an active state upon receipt of an activation signal at the security beacon device in response to a trigger event including an emergency situation that initiates a process in the activation module that causes the security beacon device to transition from the passive state to an active state;
a processing module coupled to the activation module and configured to create a user message in response to the activation of the security beacon device, wherein the user message comprises security beacon device identification information, user profile information, and trigger event message that initiates a response process at a server for addressing the trigger event associated with the user message;
a transmitting module coupled to the processing module and configured to transmit the user message from the processing module to a server for addressing the trigger event associated with the user message.

20. The device of claim 24, further comprising a recording module configured to record the general surrounding of the security beacon device when the security beacon device enters the active state.

21. The device of claim 24, wherein the user message further comprises the recording of the surrounding of the security beacon device.

22. The device of claim 24, further comprising a memory module configured to store the recording of the recording module.

23. The device of claim 24, wherein the processing module receives location signals from a global positioning system.

24. The device of claim 24, wherein the user profile information includes a pre-determined territory.

25. The device of claim 29, wherein the processing module is configured to compare the current location of the security beacon device to the boundaries of the pre-determined territory and initiate the generation of the output message in response to a determination that the device is outside of or inside of the pre-determined territory.

26. The device of claim 24, further comprising an output activation module to periodically generate an output message for transmission to the server.

27. A system for utilizing a security beacon device comprising:
an interface module for receiving and editing a user profile information;
a storage device coupled to the interface module for storing the user profile information;
a server coupled to the storage device and configured to receive a user message initiated in response to a trigger event including a security beacon device identification information, user profile information, and trigger event message, wherein the server is configured to process the user message to identify the security beacon device and to associate the security beacon device with the user profile information in the storage device to determine the appropriate response to the trigger event associated with the received user message.

28. The server of claim 27, configured to periodically receive the user message, wherein the user message comprises location information of a security beacon device that is analyzed at the server to determine if the location of the security beacon device is within a pre-determined territory.

29. The server of claim 27, further comprising a device position module coupled to the device signal reception module and configured to receive location information of the security beacon device.

30. The device position module of claim 29, further configured to log the location information over time as historical data for re-creating the historical position of the security beacon device.

31. The server of claim 27, further comprising a notification module configured to notify the appropriate authority for addressing the trigger event.

32. The server of claim 27, further comprising an output module configured to display a map of the location of the security beacon device.

33. The output module of claim 32, further configured to generate a report based on the security beacon device identification information, user profile information, location information of the security beacon device and trigger event message.
